(19) United States
(12) Patent Application Publication
(10) Pub. No.: US 2010/0205005 A1
(43) Pub. Date: Aug. 12, 2010

(54) Patient oriented electronic medical record system

(75) Inventors: Willie L. Pritchett, Indianapolis, IN (US); Jurjuan Walker, Noblesville, IN (US)

Correspondence Address: KRIEG DEVAULT LLP, ONE INDIANA SQUARE, SUITE 2800, INDIANAPOLIS, IN, 46204-2079, US

(73) Assignee: Patient Assist, LLC

(21) Appl. No.: 12/378,222

(22) Filed: Feb. 12, 2009

(51) Int. Cl. G06Q 50/00; G06Q 40/00; G06Q 90/00; G06F 9/46

(52) U.S. Cl. 705/3; 705/4; 705/8

(57) ABSTRACT

A system and method is disclosed for managing, presenting, and storing medical data. The system includes a patient assist desktop that comprises a web-enabled software application that contains numerous modules for use by patients, medical providers, pharmacies, and labs. The modules include, amongst numerous others, a family tree module that allows patients to share medical data with medical providers about members in a family nucleus as well as members in other family nucleuses.

### BACKGROUND

The present invention relates to electronically managing medical records, and more particularly, but not exclusively, relates to systems, methods, and apparatuses for electronically transferring and maintaining medical records that allows patients the ability to manage their medical profile.

Electronically maintaining medical records is becoming the standard in maintaining patient information. A vast amount of data exists for care providers to assist in making a diagnosis of a patient's symptoms. However, this information is often not available to the care provider because the medical records were not transferred, the patient is from out of town, and/or the records were not updated to include the most recent patient information. Additionally, one of the biggest frustrations for patients occurs when they enter a new care provider's office and are confronted with several forms relating to personal information and family history information to complete prior to their appointment. As such, a need exists for a method and/or system for electronically maintaining medical records that allows easy transfer of information between care providers and/or the ability to allow a patient to maintain their medical profile to quickly provide all the necessary information to their care provider.

### SUMMARY

One form of the present application discloses an electronic health care record management system designed for use by patients, healthcare providers, and pharmacies. Other embodiments include unique systems and methods of managing electronic health care records. Further embodiments, forms, objects, features, advantages, aspects, and benefits of the present application shall become apparent from the detailed description and figures included herewith.

### BRIEF DESCRIPTION OF THE DRAWINGS

The figures are not necessarily to scale, emphasis instead being placed upon illustrating the principles of the invention. Moreover, in the figures, like reference numerals designate corresponding parts throughout the different views.

FIG. 1 discloses a patient assist network diagram showing electronic devices connected to a patient assist web server.

FIG. 2 depicts a representative patient assist desktop that is generated by a patient assist application stored on the patient assist web server.

FIG. 3 is a block diagram of a patient profile module of the patient assist system.

FIG. 4 is a block diagram of a family tree module of the patient assist system.

FIG. 5 is a representative illustration of family nucleuses making up a family tree.

FIG. 6 is a block diagram of an emergency profile module of the patient assist system.

FIG. 7 is a block diagram of a create new document module of the patient assist system.

FIG. 8 is a block diagram of a prescriptions module of the patient assist system.

FIG. 9 is another block diagram showing additional features of the prescriptions module of the patient assist system.

FIG. 10 is a block diagram of the schedule appointment module of the patient assist system.

FIG. 11 is a block diagram of a send to my screen module of the patient assist system.

FIG. 12 is a block diagram of a remote data update module of the patient assist system.

FIG. 13 is a block diagram of an auditing module of the patient assist system.

FIG. 14 is a block diagram of an IVR module of the patient assist system.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention is illustrated therein being contemplated as would normally occur to one skilled in the art to which the invention relates.

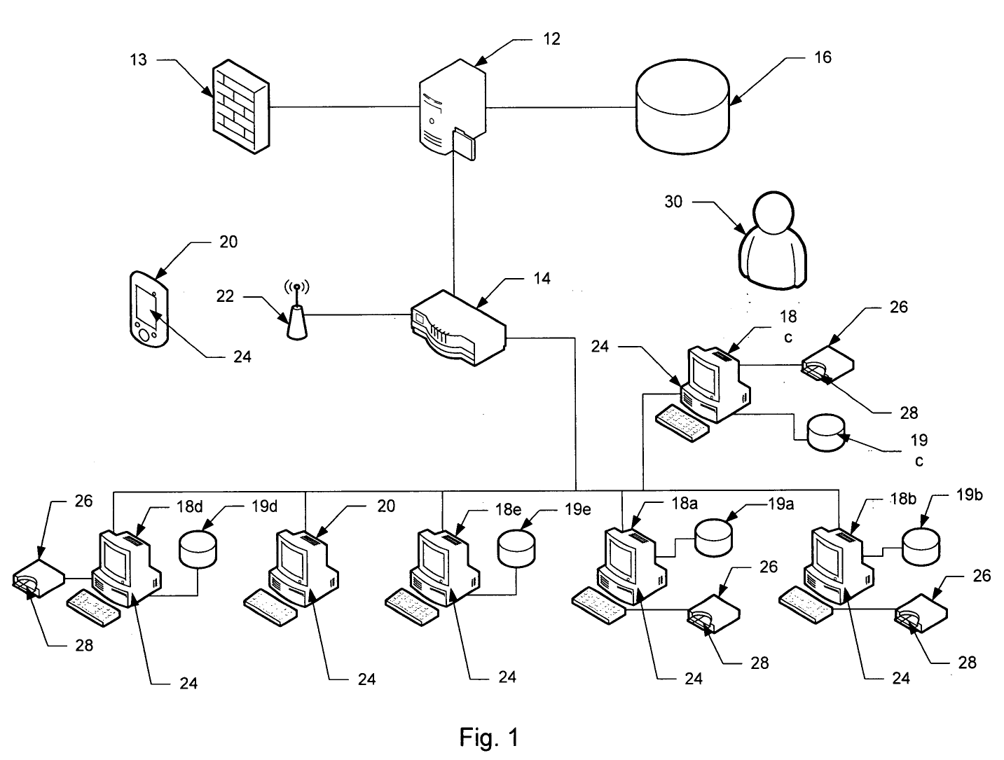

FIG. 1 illustrates an electronic healthcare record management system or patient assist system 10 that is designed to provide patients, physicians, labs, hospitals and pharmacies with patient specific data. System 10 includes at least one patient assist application server 12 that is connected with a public network 14. In one form, network 14 comprises the Internet, but may be other types of networks in other forms. As set forth in detail below, patient assist application server 12 comprises a web server that is configured and operable to generate a browser based interface that may be viewed and interacted with through web browsers on remote computing devices. A firewall 13 is connected between patient assist server 12 and network 14 to provide security to patient assist server 12.

Patient assist application server 12 includes a medical record database 16 that houses or stores a plurality of medical records. As used herein, the term medical record is used to refer to records generally created and kept by health care providers about patients. Health care providers may comprise physicians, surgeons, dentists, pharmacists, therapists, laboratory personnel, nurses, and so forth. As known in the art, health care providers generally keep records about health conditions of a patient, such as diseases, injuries, treatment plans, medical history and illnesses. In addition, health care providers also keep information about a patient's insurance provider or carrier so that the health care provider can bill the insurance company for services that are provided to the patient.

As illustrated in FIG. 1, system 10 includes a plurality of health care provider computing devices or systems 18a-e that are connected to network 14. For example, computing device 18a comprises a computer system at a doctor's office, computing device 18b comprises a computer system at a hospital, computing device 18c comprises a computer system at a dentist's office, computing device 18d comprises a computer system at a pharmacy, and computing device 18e comprises a computer system at a lab office. Each health care provider computing device 18a-e includes a patient database 19a-e that contains information and medical records about patients. One or more patient computing devices or systems 20 is also connected with network 14. In one form, patient computing device 20 is a personal computer and in other forms can be a smart phone or other portable device configured to access network 14 through a wireless access point or network 22.

Each computing device 18a-e, 20 includes a web browser 24 that is operable to display text, images, and other types of information typically available on a web page at a web site via rich Internet applications (“RIAs”). As known in the art, a web browser is a software application that enables a user to display and interact with text, images, and other information typically located on a web page at a website on the World Wide Web or a local area network. RIAs are web applications that have the features and functionality of traditional desktop applications.

As further illustrated in FIG. 1, system 10 also includes a plurality of smart card readers 26 connected with browser-enabled computing devices 18a, 18b, 18c, and 18d. Smart card readers 26 are configured and operable to read smart cards 28 that are associated with each patient 30. Smart cards 28, sometimes referred to as chip cards, or integrated circuit cards, are pocket-sized cards with embedded integrated circuits that contain data about each patient. In one form, each smart card is programmed to store or contain information about each respective patient 30 including, but not limited to, personal identification data (name, address, telephone number, email address, age, social security number, relative data (i.e.—spouse, parents, and so forth)), employment information, insurance information, and patient assist information (user identity and password).

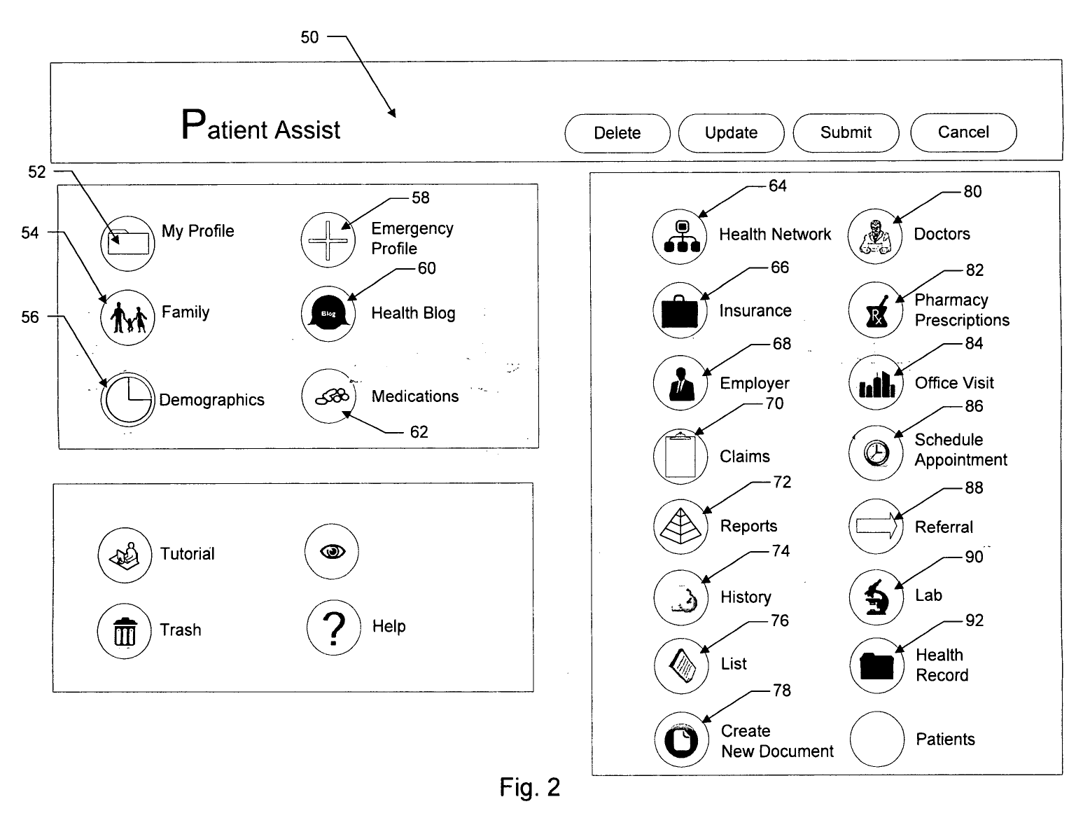

Referring to FIG. 2, system 10 includes a patient assist desktop application or module 50 that is generated on web browser 24 when a patient 30 logs into system 10 using patient computing device 20. In one form, each of the modules disclosed and discussed herein comprises an RIA that is configured and operable to run on web browsers 24 on any machine that is connected with network 14. In other forms, the patient assist desktop application can comprise a stand alone system that is not ran in a web browser 24. However, preferentially system 10 is a web-enabled application that is stored on system server 12.

As illustrated, patient assist desktop 50 includes a plurality of software modules or routines that are configured and operable to be executed via web browser 24. In particular, desktop 50 includes a patient profile module 52, a family tree module 54, a demographics module 56, an emergency profile module 58, a health blog 60, a medications module 62, a health network module 64, an insurance module 66, an employer module 68, a claims module 70, a claims module 72, a reports module 74, a history module 76, a list module 78, a create new documents module 80, a doctor module 82, a pharmacy prescriptions module 84, an office visit module 86, a schedule appointment module 88, a referral module 90, a lab module 92, a health record module 94, and a patients module 96. Once a user selects a respective one of the modules 52-96, the selected module executes in the patient's 30 web browser 24.

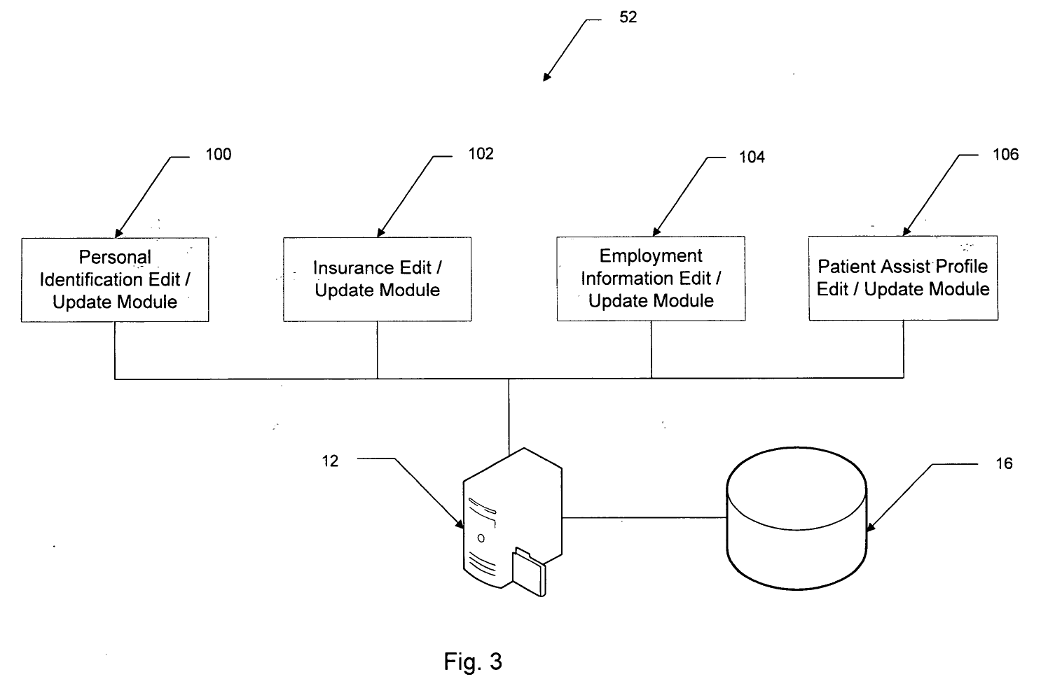

Referring to FIG. 3, patient profile module 52 includes a personal identification update module 100, an insurance update module 102, an employment update module 104, and a patient assist profile update module 106. Personal identification update module 100 is configured and operable to allow patient 30 to update various types of personal information associated with patient 30 stored in patient medical information database 16. In particular, in one form patient 30 is capable of viewing, modifying or updating their name, address, contact information, social security number, and so forth. Insurance update module 102 is configured and operable to allow patient 30 to view, modify or update their insurance information, such as their medical, dental, and optical insurance information (e.g.—provider names, plan numbers, and so forth). Employment information update module 104 is configured and operable to allow patient 30 to view, modify or update employment information (i.e.—name of employer, address, contact information, and so forth) stored in database 16. Patient assist profile update module 106 is configured and operable to allow patient 30 to view, modify or update their profile (i.e.—username and password) associated with system 10.

As illustrated in FIG. 2, desktop 50 includes family tree module 54. Family tree module 54 is configured and operable to allow families to share medical information with each other. This is important in modern medicine because of medical conditions that may be genetically passed along to other family members down the family tree. For example, if breast cancer or heart disease is known to run in the family, a doctor might like to know this information. At a minimum, members in the family tree might like to know this type of information and be able to view prior medical history, even of members that have passed away, so that they can inform their respective care providers of the family medical history.

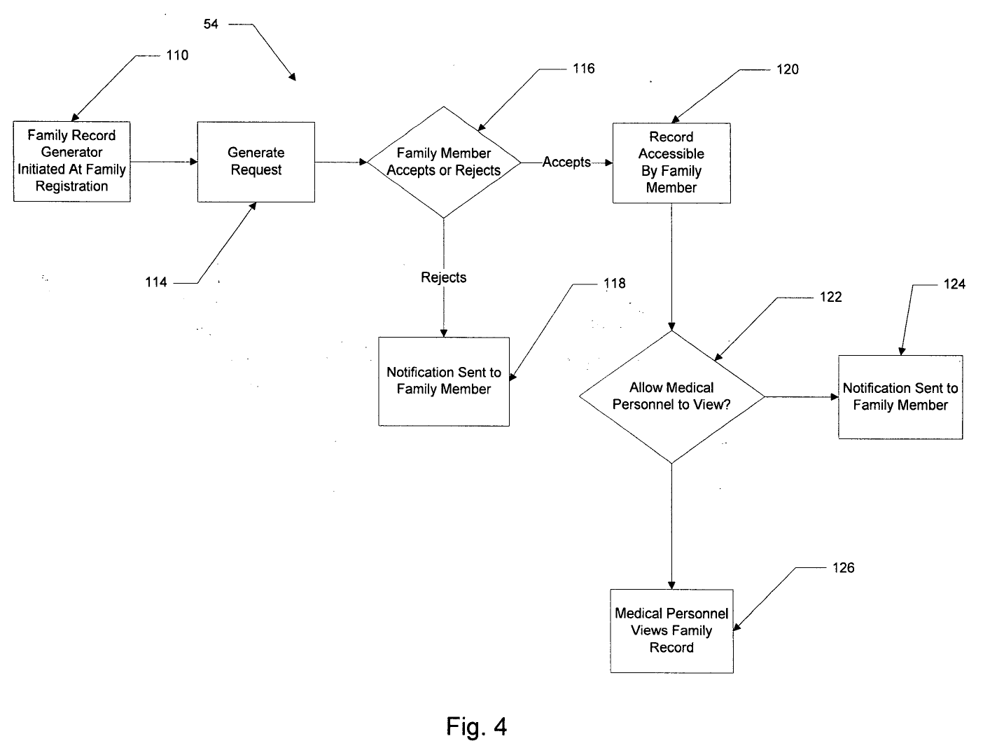

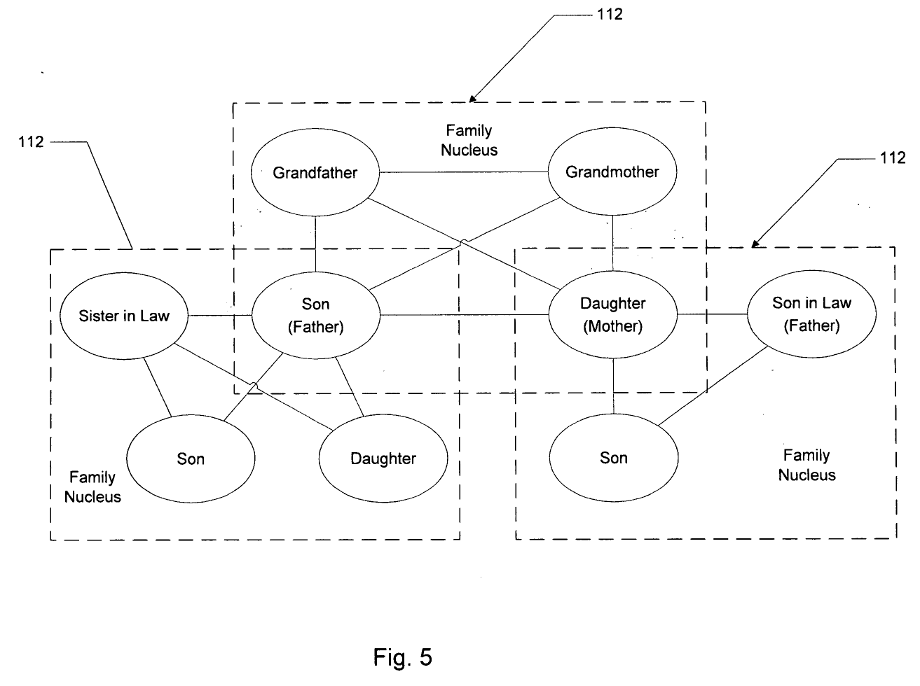

Referring collectively to FIGS. 4 and 5, upon selection of the family tree module 54, a family record generator module 110 is included that allows families initially registering for system 10 to begin by creating a family nucleus 112. In this illustrated example, the initial family nucleus is represented as a grandfather and grandmother as well as their children if they have had any at that particular time. However, the grandfather is also a part of another family nucleus because he is the son of his parents; so he would also be a part of their family nucleus. So to define the family nucleus, it is the relationship between a parent/spouse and child.

Each parent, as long as they stay married, is considered a nucleus and if authorized, can share information between each other. As they have children, their children are added to the nucleus. When their children get over 18 or graduate from college, they are also placed inside of their own family nucleus (this is to prepare them on the system for marriage). When the child becomes married, his/her nucleus will be merged with their spouse and the cycle starts over. The new family becomes the primary nucleus for the son/daughter with their spouse and the relationship to their parents becomes secondary, and so on.

Family tree module 54 allows family members to set up relationships so that medical records are shared with other family members as well as medical providers. At step 114, family tree module 54 is configured to generate a request that is sent to another family member already registered and set up to use system 10. At block 116, the family member receiving the request either accepts or rejects the family members request for access to their respective medical records stored in database 16. If the family member rejects the request, at step 118 a notification is generated that is sent to the family member requesting access that indicates the family member rejected his/her request. If the family member receiving the request accepts the request, family tree module 54 allows access to the family member's medical records.

In another form, system 10 can be set up to allow medical providers to access other family member's records other than their respective patient. As such, at step 122 the family member who has allowed access to their medical records to another family member is presented with an option to further allow medical providers of the other family member to have access to their respective medical records as well. At step 124, if the family member denies access to the other family member's medical providers, then a message is generated and sent to the denied family member. If the family member decides to grant access, then at step 126 system 10 is configured to grant access to medical providers.

As such, system 10 is capable of providing limited access to medical records to those individuals falling under a family tree. As illustrated in FIG. 5, links 128 are established with other family members when access rights have been granted. Within these access rights are other rights, such as allowing medical providers of other family members to gain access to their respective medical records stored in database 16. This is beneficial because, for example, a son's doctor may use computing device 18a to determine if heart disease runs in the family by accessing his mother and father's medical records stored in database 16. System 10 is also capable of allowing individual family members to determine what access rights other have to their respective data. For example, in one form, a family member may choose to grant medical providers of another family member access to their data, but not the other members of the family.

Referring back to FIG. 3, desktop 50 includes demographics module 56. Demographics module 56 allows users to view information associated with their family nucleus. In particular, in one form patient 30 is capable of using demographic module 56 to view, modify or update the names, addresses, contact information, social security numbers, and so forth, of family members in their family nucleus 112. In particular, patient 30 can use demographic module 56 to view, modify, and update information related to their children. Parents will have access to the medical records of their children that are stored in database 16 and the parents will be able to update information associated with children up until a predetermined age or status in life is reached (e.g.—18 years old, emancipated, married, graduating from college, and so forth).

Desktop 50 includes emergency profile module 58. Emergency profile module 58 is configured to allow patient 30 to designate the type of medical information that is displayed immediately on computing devices 18a-18e during emergency medical situations. For example, a user might be traveling and have an emergency that requires a visit to a hospital at which hospital computing device 18b might be used to access a patient's medical records stored in database 16. In some instances, patient 30 may not be conscious or capable of providing medical providers with critical information about their medical history. In these instances, smart card 28 can be used by hospital computing device 18b to gain instant access to medical records stored in database 16 about patient 30.

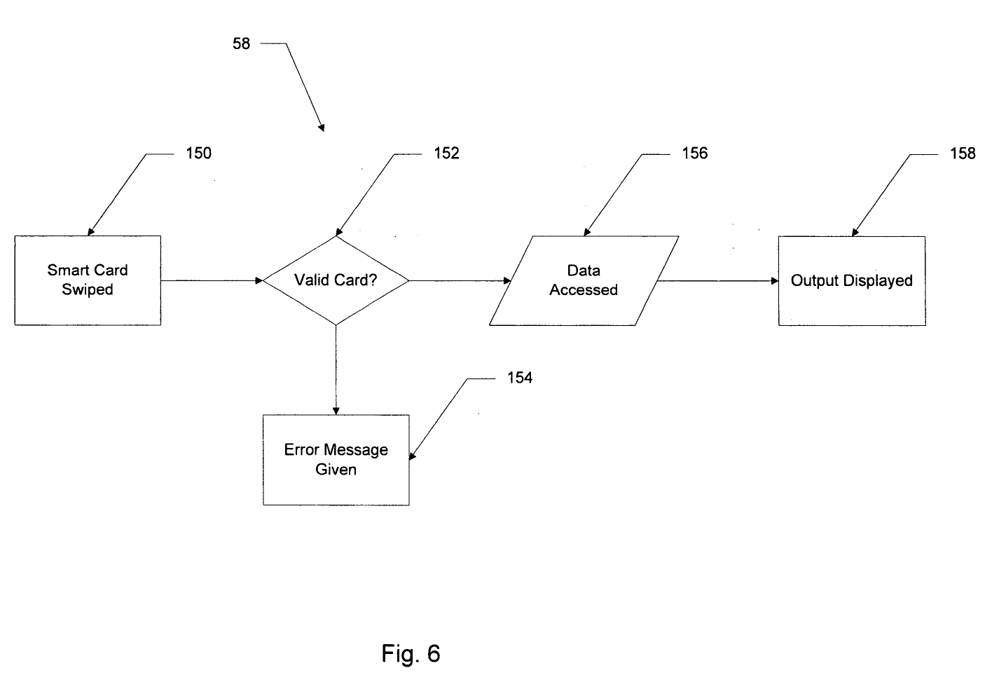

Referring to FIG. 6, emergency profile module 58 is configured to detect a smart card swipe, which is illustrated at step 150. At step 152, emergency profile module 58 on system server 12 receives information relating to a smart card swipe and determined if the smart card 28 is a valid smart card. If the swiped smart card 28 is not a valid smart card 28, emergency profile module 58 generates an error message that is sent to hospital computing device 18b, which is represented at step 154. If the smart card 28 is a valid smart card, at step 156 emergency profile module 58 accesses and pulls up the patient's medical records stored in database 16. At step 158, the medical record data is transmitted from system server 12 to hospital computing device 18b where it is displayed to medical providers.

In one form, the medical data that is transmitted to the medical providers at the hospital by the emergency profile module 58 is user selected medical data or data that is pre-designated by patient 30. For example, the information or data transmitted could be selected from a group of data such as dental history, prescription history, illness history, designated emergency history, insurance information, employer information, family contact information, and so forth.

Referring back to FIG. 3, desktop 50 also includes a health network module 64. Health network module 64 is configured and operable to display information regarding physicians in various geographic locations. Various types of data about physicians in numerous geographic locations are also stored in database 16. Health network module 64 allows patients 30 to search, view, and print out various types of data about medical providers. For example, if a patient 30 is in need of a new dentist, the patient 30 may use health network module 64 to locate a new dentist in a designated geographic area.

Desktop 50 also includes insurance module 66, which like the other modules discussed herein, is a web-enabled application presented to patient 30 via web browser 24. Insurance module 66 is configured and operable to allow patient 30 to view, update and modify various types of insurance information that is stored in database 16. This information may consist of the name of the insurance provider, the patient's insurance identification information, group numbers, policy numbers, and so forth. In addition, insurance module 66 can also provide the patient 30 with access to insurance specific information, such as benefits information, physicians in networks, contact information for people at the insurance company, links to the insurance company's website and so forth.

Employer module 68 is a web-enabled application that allows patient 30 to view, modify and update employment information associated with patient 30 that is stored in database 16. This information consists of employer name, employer address, and employer telephone and fax numbers. If patient 30 changes employment, patient 30 can use employer module 68 to change relevant information.

System 10 also includes claims module 70. Claims module 70 is a web-enabled application that is configured and operable to allow patient 30 to view claims that have been submitted to the patient's insurance company for payment. Claims module 70 is also configured to display claims that have been paid on behalf of the patient 30. This is allows patient 30 to keep track on what claims have been turned in for payment by any physician the patient visits. In the case of children, one or both parents are allowed to view claims that have been submitted on behalf of their children that fall within the family nucleus 112. Patient 30 is capable of creating a query using the claims module 70 to pull up a list of claims stored in database 16 for any given period of time. As with other modules, patient 30 uses patient computing devices 20 to access this data stored in database 16.

Reports module 72 is a web-enabled application that is configured and operable to allow patient 30 to generate reports of the medical data contained in database 16. Database 16 stores numerous types of medical data associated with patient 30, such as dates of doctor visits, dates of emergency room visits, prescription data, lab reports, and insurance information such as the amounts paid to medical providers by the patient's insurance company.

History module 74 is a web-enabled application that is configured and operable to allow patient 30 to gain access to their entire medical history that is stored in database 16. In the case of a parent, patient 30 is allowed access to the entire medical history of their children within their family nucleus 112. History module 74 contains search query fields that allow patient 30 to search for virtually any medical data they desire to locate. List module 76 is a web-enabled application that is configured and operable to allow patient 30 to save various types of lists of “to-do” items as it relates to their medical records.

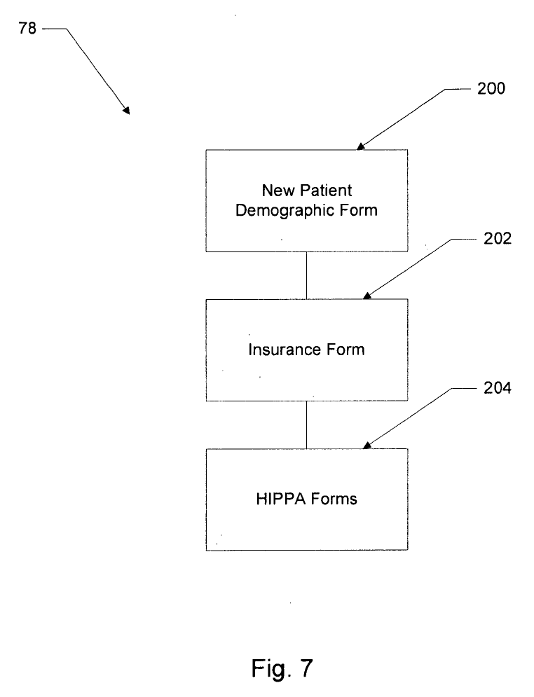

Referring to FIGS. 3 and 7, create new document module 78 is a web-enabled application that is configured and operable to generate one or more online forms that a patient 30 would typically fill out when visiting a doctor for the first time. In this form, create new document module 78 includes one or more new patient demographic forms 200, one or more insurance forms 202, and one or more HIPPA related forms 204. Demographic forms 200 are utilized by the doctor's office and transmitted from the system server 12 to the medical provider's computing device 18a-e. Demographic forms 200 allow the medical provider's support staff to gather required information from the patient prior to the visit. For example, some types of information that might be included in these forms 200 would be name, address, contact information, emergency contact information, drug allergies, and prior medical history data. These forms can be stored locally on the medical provider's computing device 18a-18e or in database 16.

Insurance forms 202 can also be generated that require patient 30 to input data about the patient's insurance coverage. Again, this could be the name of the insurance company, the address of the insurance company, the telephone and fax numbers of the insurance company, policy numbers, group numbers, and personal identifiers. HIPPA forms 204 can also be generated that could be executed by the patient 30 prior to the visit.

Referring back to FIG. 3, doctor module 80 keeps track of the current medical providers being utilized by each individual patient 30. As such, once a respective user of system 10 is granted access to a family member's medical records, he/she may utilize the doctor module 80 to view each medical provider used by that family member. Doctor module 80 can also be configured so that only medical providers of the family nucleus 112 can be viewed.

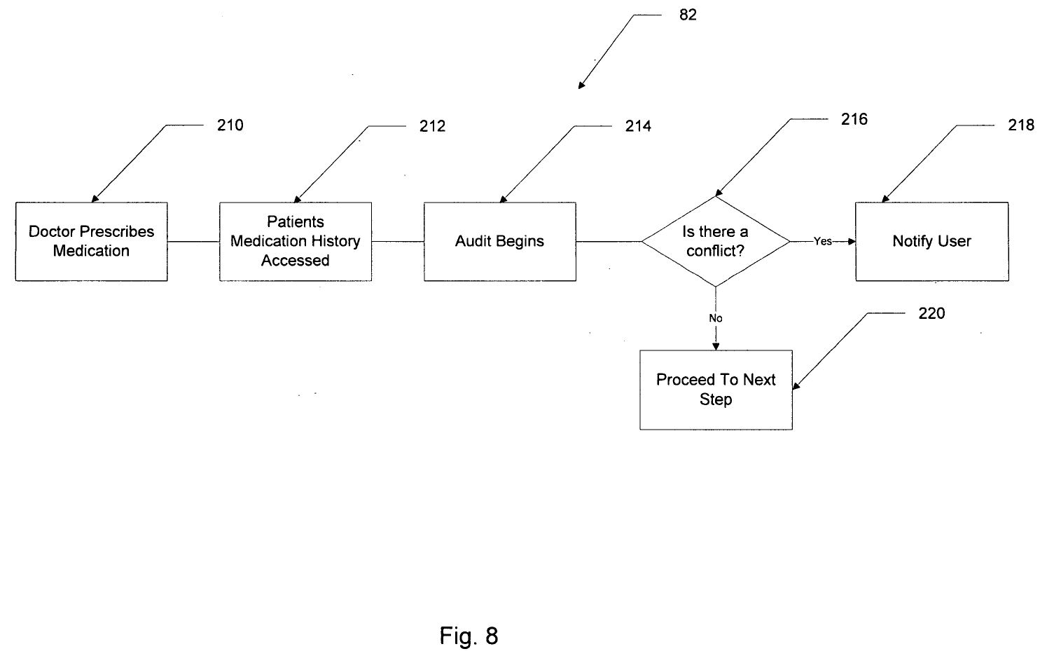

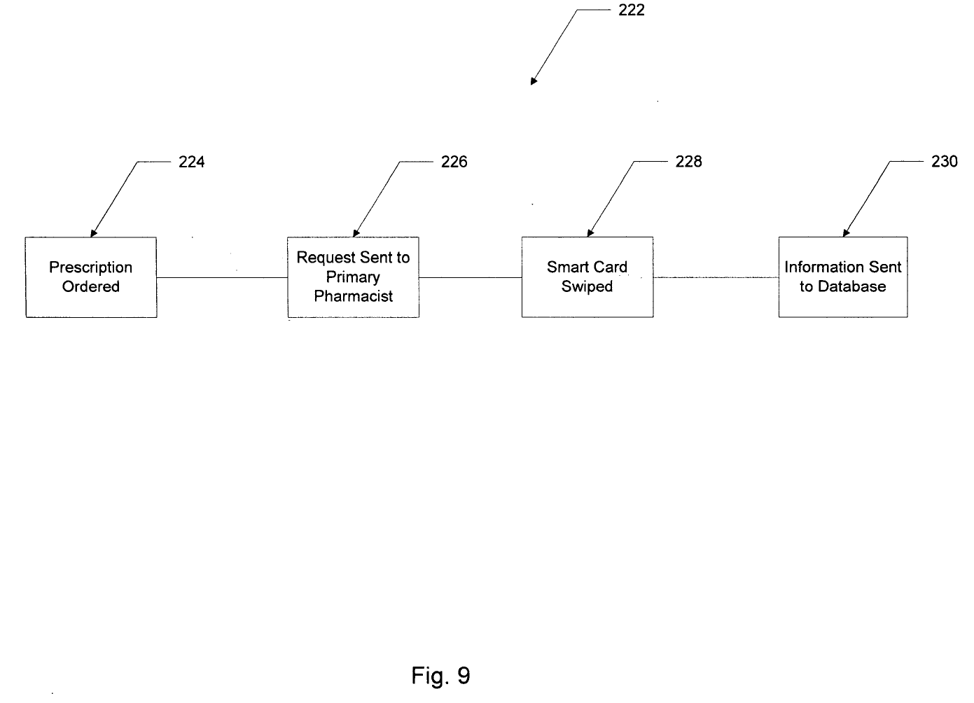

Referring to FIGS. 3, 8 and 9, system 10 can also include a prescriptions module 84. At step 210, a medical provider prescribes a medication. The medication prescribed is entered into system 10 through a medical provider computing device 18a-18e. Once the prescription is entered into system 10, prescriptions module 82 accesses the patient's medication history stored in database 16, which is represented at step 212. At this point, prescriptions module 82 begins an audit of the patient's medication history in comparison to the currently prescribed medications, which is represented at step 214. At step 216, prescriptions module 82 determines if a conflict exists with the medication being prescribed by the medical provider and any other prescriptions that may have been prescribed to the patient 30 in the past. If a conflict exists, at step 218 prescriptions module 82 generates an alert that is sent to the medical provider and optionally, to patient 30. If no conflict exists, at step 220 prescriptions module 82 proceeds to a prescription ordering module or application 222, which is represented in FIG. 9.

Prescription ordering module 222 is configured and operable to generate an electronic prescription order, which is represented at step 224. Once the order has been generated, at step 226 the prescription is sent to the patient's primary pharmacist. The contact information for the primary pharmacist is contained in database 16 and can be modified by the patient 30 at any time. In one form, once the patient 30 arrives at the pharmacy he/she can swipe their smart card 28 in the smart card reader 26 associated with pharmacy computing device 18d, which is represented at step 228. This causes pharmacy computing device 18d to generate a message that is sent to system server 12 indicating that the patient 30 has filled the prescription, which is represented at step 230. In turn, prescription ordering module 222 is configured to update database 16 indicating that the patient picked up the prescription.

Referring back to FIG. 3, system 10 also includes an office visit module 84. Office visit module 84 comprises a calendar application that contains a schedule showing scheduled appointments for medical providers. In one form, the office visit module 84 only calendars appointments in the immediate family nucleus 112. In other forms, office visit module 84 is configured and operable to display appointments with medical providers for each family member designated by a respective user. As set forth below, appointments in the calendar are automatically entered once a medical provider accepts an appointment request.

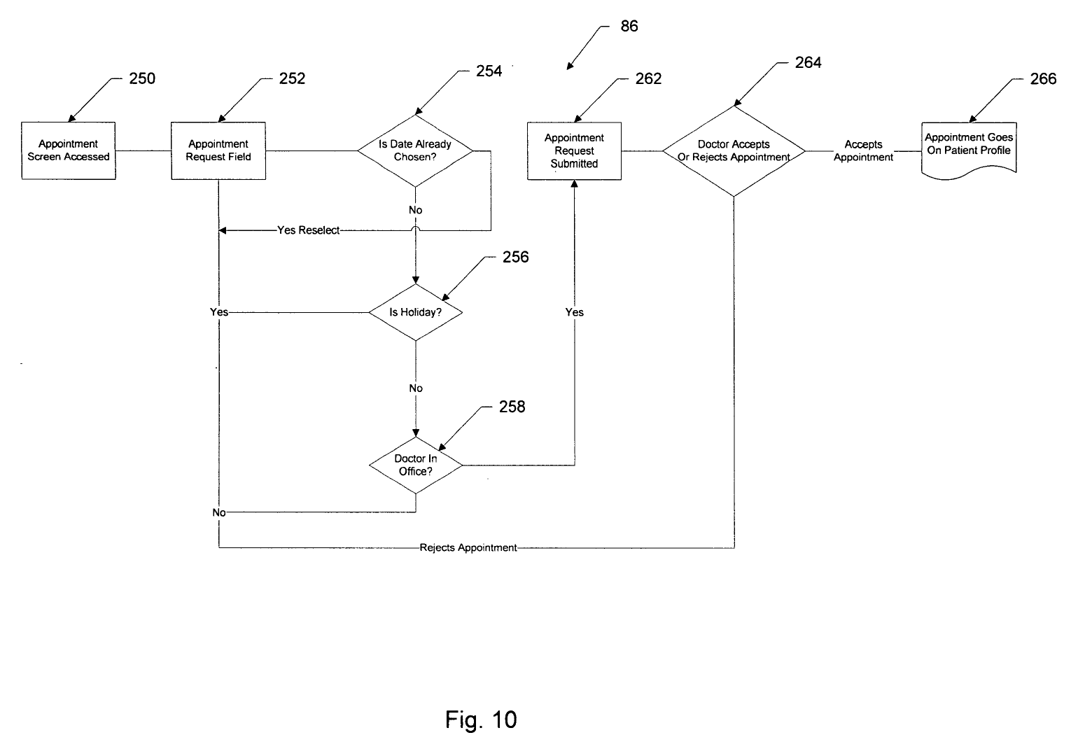

System 10 includes a schedule appointment module 86 that is configured and operable to allow patients 30 to schedule appointments with various medical providers. Referring to FIG. 10, once the schedule appointment module 86 is initiated, the patient 30 is presented with their list of medical providers, which is obtained from database 16 and represented at step 250. At this point, the patient can fill out an appointment request, which is represented at step 252. At step 254, if the date and time is chosen properly by the patient 30, then at step 256 the schedule appointment module 86 is configured to check to see if the chosen date is a holiday. If the date and time is not chosen properly, then schedule appointment module 86 reverts back to step 252.

If the schedule appointment module 86 determines that the requested date is not a holiday, then at step 258 the schedule appointment module 86 accesses the medical provider's calendar, which is stored in a database 19a, to determine if the medical provider is in the office that day. If the medical provider is not end the office, then the patient 30 is directed back to step 252 to pick another date and time. If the medical provider is in the office, then at step 260 the schedule appointment module submits the appointment request to the medical provider at step 262.

The medical provider can then access medical provider computing device 18a to either accept or reject the requested appointment, which is represented at step 264. If rejected, a notification is sent to the patient 30 directing them back to step 252. If accepted, a notification is sent to system server 12 that causes the schedule appointment module 86 to enter the appointment in the patient's calendar contained in the office visit module 84, which is represented at step 266. Further, other types of notifications can also be sent such as text messages, email messages, automatic phone messages, and so forth.

Referring once again to FIG. 3, system 10 includes a referral module 88. In one form, referral module 88 is configured and operable to allow the patient 30 to request a referral from a primary care physician to a specialist. In another form, referral module 88 is configured and operable to allow the patient's primary care physician to make referrals to specialists. A notification of the referral is sent to the patient once placed and then the patient 30 can use the schedule appointment module 86 to schedule an appointment with the specialist.

Lab module 90 allows patients 30 to view and download lab results that may be generated by labs. The lab results would typically be stored in a database 19e associated with a lab computing device 18e. In one form, lab computing device 18e is configured and operable to transmit the lab results to database 16. In other forms, the lab results may be permanently stored and accessed by the patient and medical providers from lab computing device 18e.

A health record module 92 is also included that is configured and operable to allow the patient 30 to download their entire medical history in a portable format. For example, in one form, health record module 92 is configured to convert the patient's entire medical history into a portable document format that the patient 30 can do with as they like. In addition, medical providers who have access to system 10 and medical records stored in database 16 for respective patients are also capable of downloading the patient's entire medical history in various formats compatible with their respective computing systems.

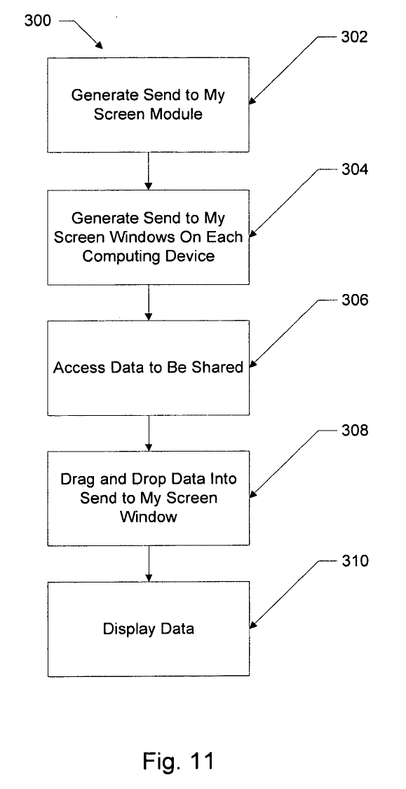

Referring to FIGS. 3 and 11, another feature of system 10 is a send to my screen module 300. Send to my screen module 300 allows two physicians to collaborate with one another in a real time basis for a respective patient 30. For illustrative purposes only, patient 30 is admitted into a hospital for an emergency matter. The emergency room medical provider uses system 10 to locate the patient's primary care physician because he/she would like to discuss the patient's medical history with the primary care physician about treatment options. In particular, send to my screen module 300 allows medical providers to share data on a real time basis, some of which may be newly obtained and not yet available in database 16.

Using system 10, each medical provider would initiate the send to my screen module 300, which is represented at step 302. Upon initiation, at step 304 send to my screen module 300 generates send to my screen windows on a display associated with each medical provider's computing device, which in our present example would be doctor computing device 18a and hospital computing device 18b. Once the send to my screen windows have been generated on each respective computing device 18a, 18b, one of the medical providers would access the data to be shared with the other medical provider, which is represented at step 306. In this instance, this data may be stored locally on doctor computing device 18a, locally on hospital computing device 18b, or within database 16.

After the relevant data file to be shared has been located by the medical provider, the send to my screen module 300 allows the medical provider to drag and drop the data file into the send to my screen window that was created at step 304. The send to my screen module 300 is then configured to generate an image of the data file that is being shared in both send to my screen windows on each computing device 18a, 18b, which is represented at step 310. For example, if the emergency room had just obtained and X-ray or MRI results, these data files could be shared on a real time basis with the patient's primary care physician. Likewise, the primary care physician could share data files stored locally in doctor computing device 18a or medical records he/she might know to exist that are particularly relevant to the condition of the patient from database 16.

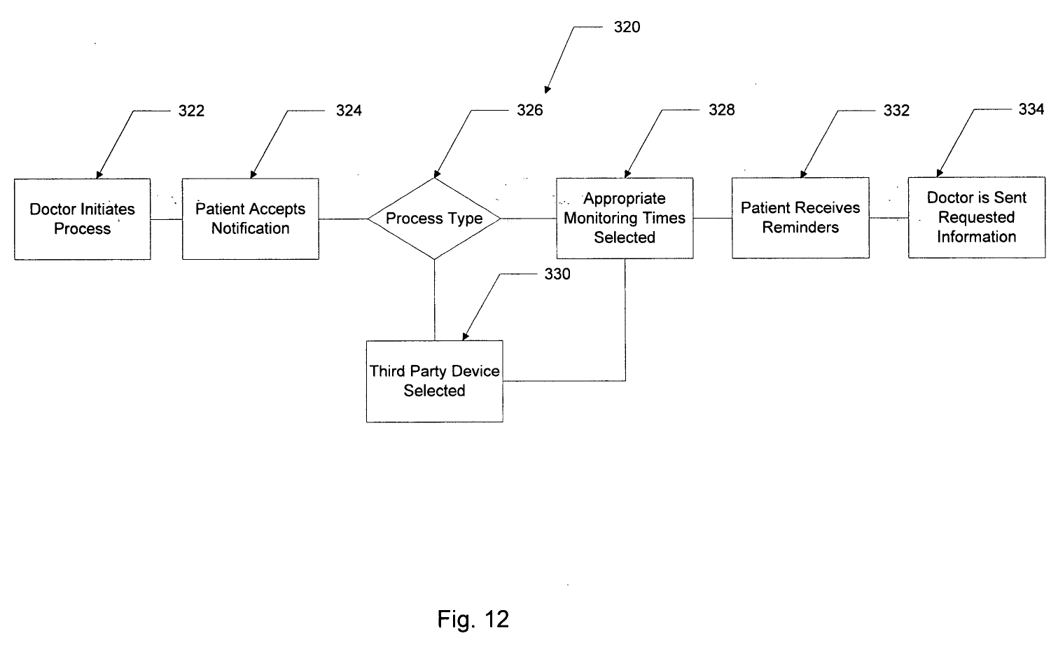

Referring to FIG. 12, in yet another form system 10 can be configured with a remote data update module 320. In this form, a medical provider desires to receive periodic types of data from the patient 30. For example, if the patient is being monitored for an illness or is a diabetic, the medical provider may want periodic updates about certain symptoms or conditions (e.g.—temperature, blood pressure, blood sugar levels, and so forth). As such, remote data update module 320 is configured and operable to allow the medical provider to set it up so that he/she can obtain the relevant data from the patient 30.

At step 322, the medical provider sets up the medical data parameters that he/she wants reported to them using the remote data update module 320. Once again, this is a web-enabled browser based application that would run on a computing device, such as doctor computing device 18a. Remote data update module 300 then transmits a notification to the patient notifying them of the fact that the medical provider desires for them to provide them with the respective medical data parameters, which is represented at step 324. If the process involves obtaining medical data parameters from a third-party device, the patient 30 is prompted to select the type of electronic device that will be reporting the medical data parameters, which is represented at step 326. If no third party electronic devices are required, remote data update module 320 proceeds to step 328.

If a third party electronic device is being utilized to obtain the respective data, the patient will select the third party device, which is represented at step 330. At step 328, the patient 30 is prompted to select or reminded of appropriate monitoring times in which the medical data parameters should be submitted. In one form, remote data update module 320 is configured and operable to generate automatic electronic reminders that are sent to the patient 30 reminding the patient to submit the required data, which is represented at step 332. At step 334, the remote data update module 300 is configured and operable to be accessed by the patient 30 to send the required medical data parameters or information.

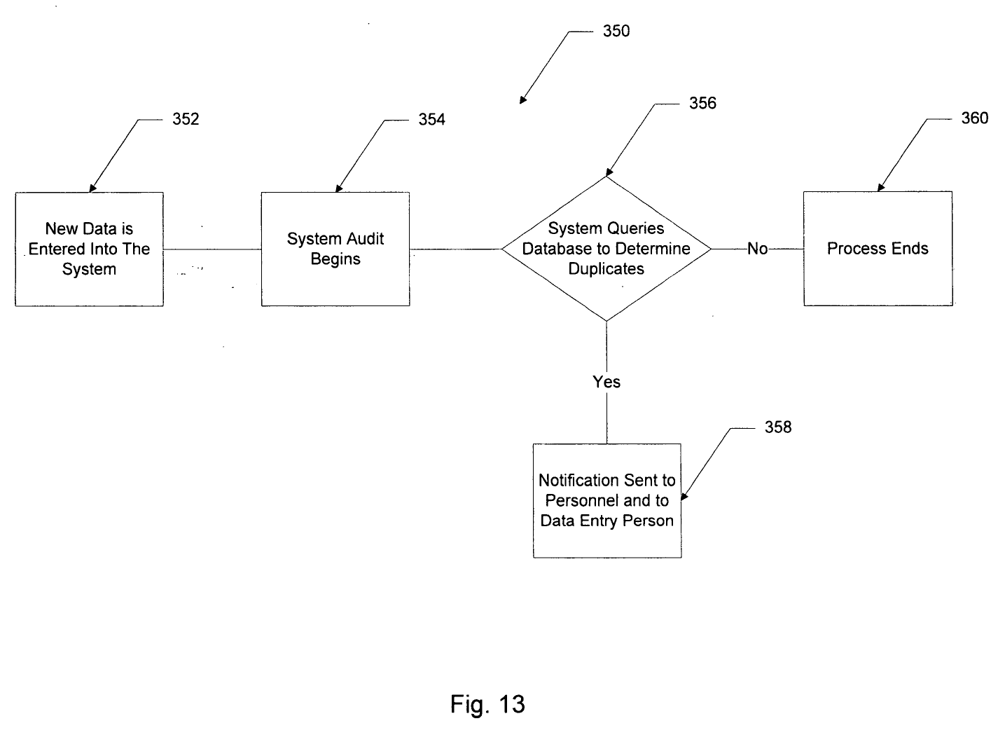

Referring to FIG. 13, system 10 can also include an auditing module 350 that is configured and operable to allow system 10 to audit database 16 to minimize mistakes and errors. At step 352 any type of new medical data is entered into system 10 and stored in database 16. Whenever new data is entered, a system audit begins to determine if duplicates of the data are already stored in database 16, which is represented at step 354. At decision block 356, the auditing module 350 queries database 16 to determine if any duplicates do in fact exist to the newly entered data. If a duplicate exists, at step 358 a notification is sent to personnel running system 10 as well as the entity or person that entered the data at step 352. If the auditing module 350 does not determine that a duplicate entry exists, then at step 360 the auditing module 350 terminates the audit.

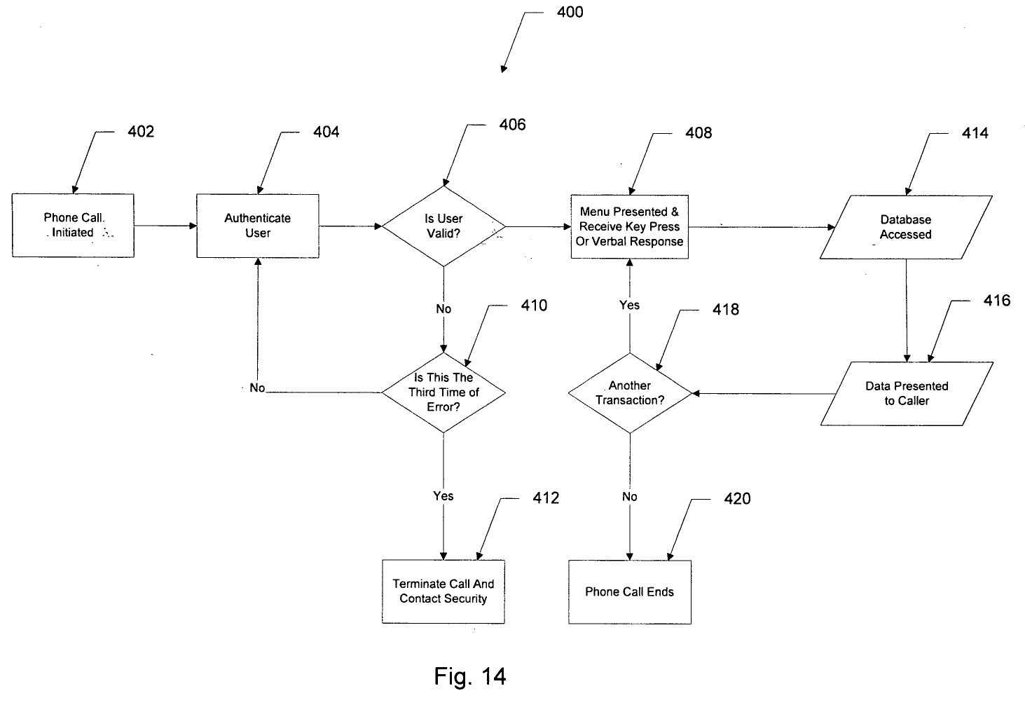

Referring to FIG. 14, system 10 can also include an interactive voice response (“IVR”) module 400. IVR module 400 allows users to obtain data from database 16 through the use of pre-recorded voice prompts and menus and touch-tone keypad entry to gather responses from the person requesting information. In addition, the present IVR module 400 is also enable responses to be gathered via spoken words with voice recognition.

At step 402, a phone call is initiated by a person that desires to obtain information from database 16. Once the call is received by server 12, IVR module 400 is configured and operable to authenticate the caller, which is represented at step 404. Because system 10 deals with healthcare records, it is extremely important to authenticate anyone who receives access to data stored in database 16. At decision block 406 a determination is made as to whether or not the user is a valid user. If the user is valid, at step 408 an option menu is presented to the caller and the caller is allowed to either press a key or enter a verbal response. If the user is invalid, at decision block 410 the IVR module 400 determines if this is the third time the caller as attempted to be authenticated. If it is not the third time, the caller is directed back to step 404. If it is the third time, the call is terminated by the IVR module 400 and security is notified, which is represented at step 412.

At step 414, once the caller has identified the data they desire to obtain from database 16, IVR module 400 accesses database 16 and retrieves the data needed by the caller. At step 416, the data retrieved from the database 16 is presented to the caller. Once the data is presented to the caller, the caller is presented with the option to conduct another transaction or data request, which is represented at step 418. If the caller elects to conduct another data request, IVR module 400 returns the caller to step 408. If not, the phone call is terminated by the IVR module 400, which is represented at step 420.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A system, comprising:
a medical information server connected with a network;
a medical information database associated with the medical information server;
a plurality of patient medical records stored in the medical information database;
a patient desktop application configured to provide access to a plurality of software modules through the use of a patient computing device connected with the network, where one of the software modules comprises a family tree module that links medical records from a plurality of family members related to an individual patient; and
a plurality of medical provider computing devices connected to the network having software configured to communicate with the medical information server and obtain and update medical records associated with one or more of said plurality of family members.

2. The system of claim 1, where the family tree module is configured to only allow authorized family members to have access to medical records of other family members.

3. The system of claim 2, where the family tree module is configured to only allow authorized medical providers to have access to medical records of other family members.

4. The system of claim 3, further comprising a send to my screen module configured to allow at least two medical providers at different locations to share medical data concerning a respective patient in real time.

5. The system of claim 4, further comprising a patient profile module configured to allow an individual to view or update personal identification information, insurance information, and employment information.

6. The system of claim 5, further comprising an emergency profile module configured to transmit medical information to a respective medical provider computing device upon detection of a valid smart card swipe.

7. The system of claim 6, further comprising a health network module configured to display information regarding physicians located in one or more geographic locations.

8. The system of claim 7, further comprising a claims module configured to display claims that have been submitted to an insurance carrier for payment and claims that have been paid by the insurance carrier.

9. The system of claim 8, further comprising a reports module configured to generate a medical report associated with a respective patient by accessing the medical information database.

10. The system of claim 9, where the medical report includes dates of doctor visits, prescription data, lab reports, and dates of emergency room visits.

11. The system of claim 10, further comprising a history module configured to allow access to the entire medical history of a family nucleus stored in the medical information database.

12. The system of claim 11, further comprising a prescriptions module configured to allow a physician to prescribe a medication to a respective patient.

13. The system of claim 12, where the prescription module is configured to determine if a conflict exists with the medication being prescribed by the physician and one or more other medications that the patient is currently taking.

14. The system of claim 13, where the prescription module is configured to automatically generate an electronic prescription order that is sent to a pharmacy computing device connected to the network.

15. The system of claim 14, further comprising a office visit module configured to allow the patient to view scheduled appointments associated with family members linked to the patient by the family tree module.

16. The system of claim 15, further comprising a schedule appointment module configured to allow the patient to schedule an appointment with a respective medical provider.

17. The system of claim 16, further comprising a health record module configured to generate a medical history file that is downloadable in a portable format.

18. A method, comprising the steps of:
storing a plurality of medical records in a medical record database;
allowing a patient to gain access to the medical records stored in the medical record database; and
allowing a patient to generate a family tree so that the medical records of other family members in the family tree can be accessed by a medical provider of the patient.
